(19) United States
(12) Patent Application Publication
(10) Pub. No.: US 2025/0285378 A1
(43) Pub. Date: Sep. 11, 2025

(54) IMAGE PROCESSING DEVICE, IMAGE PROCESSING METHOD, AND PROGRAM

(71) Applicant: SONY GROUP CORPORATION, TOKYO (JP)

(72) Inventor: YOSHIYUKI TAKAO, TOKYO (JP)

(21) Appl. No.: 18/862,604

(22) PCT Filed: Apr. 27, 2023
(86) PCT No.: PCT/JP2023/016576

§ 371 Date: Nov. 4, 2024

(30) Foreign Application Priority Data
May 12, 2022 (JP) 2022-078621

(51) Int. Cl. G06T 17/20; G06T 7/246; G06T 7/73; G06V 10/26

(52) U.S. Cl. CPC G06T 17/20; G06T 7/246; G06T 7/73; G06V 10/26; G06T 2207/20044

(57) ABSTRACT

The present disclosure relates to an image processing device, an image processing method, and a program that are capable of generating a 3D model with high accuracy even when occlusion has occurred.

The image processing device includes: a bone information estimation unit that estimates, based on captured images at a predetermined time captured by a plurality of imaging devices, bone information of a person appearing in the captured images; and a 3D model estimation unit that, when occlusion has occurred on the person appearing in the captured images at the predetermined time, estimates a 3D model of the person based on the bone information at the predetermined time. The technology of the present disclosure can be applied to, for example, an image processing device that distributes free viewpoint video.

### TECHNICAL FIELD

The present disclosure relates to an image processing device, an image processing method, and a program, and more particularly, relates to an image processing device, an image processing method, and a program that are capable of generating a 3D model with high accuracy even when occlusion has occurred.

### BACKGROUND ART

There is a technology that provides a free viewpoint video by generating a 3D model of a subject from moving images captured from a plurality of viewpoints, and generating a virtual viewpoint video of the 3D model according to any viewpoint (virtual viewpoint) (e.g., see PTL 1). This technology is also called volumetric capture. Using this volumetric capture technology, 3D streaming is being developed that captures a sports game from a plurality of viewpoints and distributes a 3D model of each player in the game to users, which are viewers, so that each user is allowed to freely change the viewpoint while watching the game.

To capture human movements such as those in sports in 3D with high accuracy, there is a technology that attempts to improve the accuracy of the 3D model shape by breaking down the human body shape (object) in a free viewpoint video content into parts and performing mesh tracking on each part in the time direction (e.g., see PTL 2).

A rigged human body template model called a skinned multi-person linear model (SMPL) is known, which includes bone information (rigs) such as bones and joints and can accurately represent various human body shapes (e.g., see NPL 1).

### CITATION LIST

### Patent Literature

### PTL 1

WO 2018/150933

### PTL 2

Japanese Translation of PCT Application No. 2020-518080

### Non Patent Literature

### NPL 1

SMPL A Skinned Multi-Person Linear Model, https://smpl.is.tue.mpg.de

### SUMMARY

### Technical Problem

In a volumetric image capture environment such as sports game broadcast as described above, occlusion can inevitably occur due to limitations on the arrangement and number of cameras, the number of players for which 3D models are to be generated, and so on.

The present disclosure has been made in view of such circumstances, and aims at making it possible to generate a 3D model with high accuracy even when occlusion has occurred.

### Solution to Problem

An image processing device according to one aspect of the present disclosure includes: a bone information estimation unit that estimates, based on captured images at a predetermined time captured by a plurality of imaging devices, bone information of a person appearing in the captured images; and a 3D model estimation unit that, when occlusion has occurred on the person appearing in the captured images at the predetermined time, estimates a 3D model of the person based on the bone information at the predetermined time.

An image processing method according to one aspect of the present disclosure includes: by an image processing device, estimating, based on captured images at a predetermined time captured by a plurality of imaging devices, bone information of a person appearing in the captured images; and estimating, when occlusion has occurred on the person appearing in the captured images at the predetermined time, a 3D model of the person based on the bone information at the predetermined time.

A program according to one aspect of the present disclosure is for causing a computer to execute processing of: estimating, based on captured images at a predetermined time captured by a plurality of imaging devices, bone information of a person appearing in the captured images; and estimating, when occlusion has occurred on the person appearing in the captured images at the predetermined time, a 3D model of the person based on the bone information at the predetermined time.

In one aspect of the present disclosure, based on captured images captured at a predetermined time by a plurality of imaging devices, bone information of a person appearing in the images is estimated; and when occlusion has occurred on the person appearing in the captured images at the predetermined time, a 3D model of the person is estimated based on the bone information at the predetermined time.

The image processing device according to one aspect of the present disclosure can be realized by causing a computer to execute a program. The program to be executed by the computer can be provided by transmitting through a transmission medium or by recording on a recording medium.

The image processing device may be an independent device or an internal block constituting one device.

### BRIEF DESCRIPTION OF DRAWINGS

FIG. 1 is a block diagram of an image processing system to which the present technology is applied.

FIG. 2 is a diagram illustrating an example of the arrangement of an imaging device that captures an image of a subject.

FIG. 3 illustrates a flow of processing in the image processing system of FIG. 1.

FIG. 4 is a diagram illustrating a problem in occlusion.

FIG. 5 is a diagram illustrating an example of a captured image in a sports scene.

FIG. 6 is a diagram illustrating an example of a captured image in a sports scene.

FIG. 7 is a diagram illustrating an example of a captured image in a sports scene.

FIG. 8 is a diagram illustrating an example of a captured image in a sports scene.

FIG. 9 is a diagram illustrating an example of a captured image in a sports scene.

FIG. 10 is a block diagram illustrating a detailed configuration example of a 3D model generation unit.

FIG. 11 is a diagram illustrating the generation of an unrigged 3D model.

FIG. 12 is a diagram illustrating the generation of the unrigged 3D model.

FIG. 13 is a diagram illustrating the generation of the unrigged 3D model.

FIG. 14 is a diagram illustrating the generation of the unrigged 3D model.

FIG. 15 is a diagram illustrating the generation of the unrigged 3D model.

FIG. 16 is a diagram illustrating data of the unrigged 3D model.

FIG. 17 is a diagram illustrating the generation of a rigged 3D model.

FIG. 18 is a diagram illustrating the generation of the rigged 3D model by a rigged 3D model estimation unit.

FIG. 19 is a flowchart illustrating first 3D moving image generation processing.

FIG. 20 is a flowchart illustrating second 3D moving image generation processing.

FIG. 21 is a block diagram illustrating a configuration example of an embodiment of a computer to which the technology of the present disclosure is applied.

### Description of Embodiments

Modes for embodying the technology of the present disclosure (hereinafter referred to as “embodiments”) will be described below with reference to the accompanying drawings. In the present specification and the drawings, components having substantially the same functional configuration will be denoted by the same reference numerals, and thus repeated descriptions thereof will be omitted. The description will be made in the following order.
1. Embodiment of Image Processing System
2. Flow of Processing in Image Processing System
3. Problem in Occlusion in Sports Scenes
4. Detailed Configuration Block Diagram of 3D Model Generation Unit
5. First 3D Moving Image Generation Processing
6. Second 3D Moving Image Generation Processing
7. Conclusion
8. Computer Configuration Example
9. Application Examples

### 1. Embodiment of Image Processing System

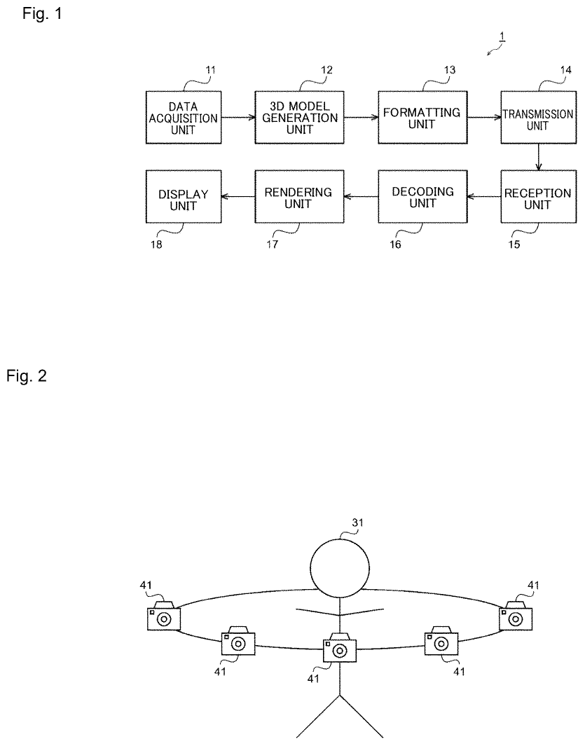

First, an overview of an image processing system to which the present technology is applied will be described with reference to FIGS. 1 to 3.

FIG. 1 is a block diagram of the image processing system to which the present technology is applied.

The image processing system 1 in FIG. 1 is a distribution system that captures images of a person, which is a subject, from a plurality of viewpoints to generate a 3D model by using the volumetric capture technology, and distributes the model to users, which are viewers, so that each user is allowed to freely change the viewpoint to view the subject.

The image processing system 1 includes a data acquisition unit 11, a 3D model generation unit 12, a formatting unit 13, a transmission unit 14, a reception unit 15, a decoding unit 16, a rendering unit 17, and a display unit 18.

The data acquisition unit 11 acquires image data for generating a 3D model of a subject. The data acquisition unit 11 acquires, for example, a) as image data, a plurality of viewpoint images (referred to as captured images or simply as images) captured by a plurality of imaging devices 41 (hereinafter referred to as cameras 41) (for a plurality of viewpoints) arranged to surround a subject 31 as illustrated in FIG. 2. In this case, the plurality of viewpoint images are preferably images captured synchronously by the plurality of cameras 41. The data acquisition unit 11 may also acquire, for example, b) as image data, a plurality of viewpoint images of a subject 31 captured by one camera 41 from a plurality of viewpoints. The data acquisition unit 11 may also acquire, for example, c) as image data, one captured image of a subject 31. In this case, the 3D model generation unit 12, which will be described below, generates a 3D model by using, for example, machine learning.

The data acquisition unit 11 acquires internal parameters and external parameters, which are camera parameters corresponding to the position (installation position) and attitude of each camera 41, from outside. Alternatively, the data acquisition unit 11 may perform calibration based on the image data to generate internal parameters and external parameters of each camera 41. The data acquisition unit 11 may acquire, for example, a plurality of pieces of depth information indicating distances from a plurality of viewpoints to the subject 31.

The 3D model generation unit 12 generates, based on image data obtained by capturing images of the subject 31 from a plurality of viewpoints, a model (3D model) having three-dimensional information of the subject. The 3D model generation unit 12 generates a 3D model of the subject by using, for example, a so-called a visual hull to sharpen the three-dimensional shape of the subject using images from a plurality of viewpoints (e.g., silhouette images from a plurality of viewpoints). In this case, the 3D model generation unit 12 can further deform the 3D model generated using the visual hull with high accuracy by using a plurality of pieces of depth information indicating distances from the plurality of viewpoints to the subject 31. For example, the 3D model generation unit 12 may generate a 3D model of a subject 31 from one captured image of the subject 31. The 3D model generated by the 3D model generation unit 12 can be said to be a moving image of the 3D model when generated on a per-frame basis in a time series. Since the 3D model is generated using the image(s) captured by the camera(s) 41, it can also be said to be a live-action 3D model. The 3D model can express shape information that represents the surface shape of a subject in the form of mesh data, for example, called a polygon mesh, which is expressed by connections between vertices. The method of expressing the 3D model is not limited to the above examples, and the 3D model may be described by a so-called point cloud expression method, which uses position information of points for expression.

In association with such 3D shape data, texture data, which is color information data, is generated. The texture data includes view independent texture data in which color information remains the same regardless of the viewing direction, and view dependent texture data in which color information changes depending on the viewing direction.

The formatting unit 13 converts data of the 3D model generated by the 3D model generation unit 12 into a format suitable for transmission and storage. For example, the 3D model generated by the 3D model generation unit 12 may be converted into a plurality of two-dimensional images by perspective projection from a plurality of directions. In this case, the 3D model may be used to generate depth information that is two-dimensional depth images from a plurality of viewpoints. The depth information as the two-dimensional images and color information are compressed and output to the transmission unit 14. The depth information and the color information may be transmitted as one image in which they are arranged side by side, or may be transmitted as two separate images. In this case, since they are in the form of two-dimensional image data, they can also be compressed using a two-dimensional compression technology such as advanced video coding (AVC).

For example, the 3D model data may be converted into a point cloud format. It may be output to the transmission unit 14 as three-dimensional data. In this case, it is possible to use, for example, a three-dimensional compression technology of Geometry-based-Approach discussed in MPEG.

The transmission unit 14 transmits the transmission data formed by the formatting unit 13 to the reception unit 15. The transmission unit 14 performs a series of processing of the data acquisition unit 11, the 3D model generation unit 12, and the formatting unit 13 offline and then transmits the transmission data to the reception unit 15. Further, the transmission unit 14 may transmit the transmission data generated from the series of processing described above to the reception unit 15 in real time.

The reception unit 15 receives the transmission data transmitted from the transmission unit 14.

The decoding unit 16 performs decoding processing on the transmission data received by the reception unit 15, and decodes the received transmission data into 3D model data (shape and texture data) required for display.

The rendering unit 17 performs rendering using the 3D model data decoded by the decoding unit 16. For example, texture mapping is performed in which a mesh of the 3D model is projected from the viewpoint of a camera that draws it, and a texture that represents color and pattern is applied. This rendering can be viewed from any free viewpoint set regardless of the camera position at the time of capturing.

The rendering unit 17 performs texture mapping to apply a texture representing the color, pattern, and quality feel of a mesh depending on the position of the mesh of the 3D model, for example. Texture mapping includes a method called view dependent that considers the user's viewing viewpoint, and a method called view independent that does not consider the user's viewing viewpoint. The view dependent method has the advantage of achieving higher quality rendering than the view independent method because it changes the texture applied to the 3D model depending on the position of the viewing viewpoint. On the other hand, the view independent method has the advantage of reducing the amount of processing compared to the view dependent method because it does not consider the position of the viewing viewpoint. The data of the viewing viewpoint is detected as the user's viewing position (region of interest) by a display device, and is input from the display device to the rendering unit 17. The rendering unit 17 may also employ billboard rendering, which renders an object so that the object maintains a vertical posture with respect to the viewing viewpoint. For example, when rendering a plurality of objects, objects that are of low interest to the viewer may be rendered as billboards, while the other objects may be rendered using another rendering scheme.

The display unit 18 displays the result of rendering by the rendering unit 17 on a display of the display device. The display device may be a 2D monitor or a 3D monitor such as a head-mounted display, a spatial display, a mobile phone, a television set, or a PC.

FIG. 1 illustrates, in the image processing system 1, a series of flows from the data acquisition unit 11 that acquires captured images, which are materials for generating content, to the display unit 18 that controls the display device on which the user views. However, this does not mean that all functional blocks are necessary to implement the present technology, and the present technology may be implemented for each functional block or a combination of a plurality of functional blocks. For example, in FIG. 1, the transmission unit 14 and the reception unit 15 are provided to indicate a series of flows from a side that creates content to a side that views the content through distribution of content data, but the flow from content creation to viewing may be implemented by a single image processing device (e.g., a personal computer). In this case, the formatting unit 13, the transmission unit 14, the reception unit 15, or the decoding unit 16 can be eliminated from the image processing device.

In implementing the image processing system 1, the same implementer may implement everything, or different implementers may implement each functional block. As an example, operator A generates 3D content through the data acquisition unit 11, the 3D model generation unit 12, and the formatting unit 13. The 3D content may then be distributed through the transmission unit 14 (platform) of operator B, and a display device of operator C may receive, render, and control to display the 3D content.

Each functional block can be implemented on the cloud. For example, the rendering unit 17 may be implemented in the display device or may be implemented in a server. In that case, information is exchanged between the display device and the server.

In FIG. 1, the data acquisition unit 11, the 3D model generation unit 12, the formatting unit 13, the transmission unit 14, the reception unit 15, the decoding unit 16, the rendering unit 17, and the display unit 18 are collectively described as the image processing system 1. However, in the present specification, the image processing system 1 will be referred to as an image processing system if two or more functional blocks are related to one another, and for example, the data acquisition unit 11, the 3D model generation unit 12, the formatting unit 13, the transmission unit 14, the reception unit 15, the decoding unit 16, and the rendering unit 17, excluding the display unit 18, can be collectively referred to as the image processing system 1.

### 2. Processing Flow in Image Processing System

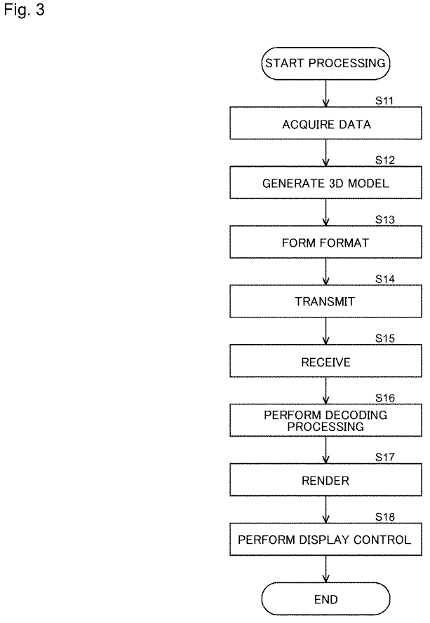

A flow of processing in the image processing system 1 will be described with reference to a flowchart of FIG. 3.

When the processing starts, the data acquisition unit 11 acquires image data for generating a 3D model of the subject 31 in step S11. In step S12, the 3D model generation unit 12 generates a model having three-dimensional information of the subject 31 based on the image data for generating the 3D model of the subject 31. In step S13, the formatting unit 13 encodes a shape and texture data of the 3D model generated by the 3D model generation unit 12 into a format suitable for transmission or storage. In step S14, the transmission unit 14 transmits the encoded data, and in step S15, the reception unit 15 receives the transmitted data. In step S16, the decoding unit 16 performs decoding processing to perform conversion into a shape and texture data required for display. In step S17, the rendering unit 17 performs rendering using the shape and texture data. In step S18, the display unit 18 displays the result of rendering. When the processing of step S18 ends, the processing of the image processing system ends.

### 3. Problem in Occlusion in Sports Scenes

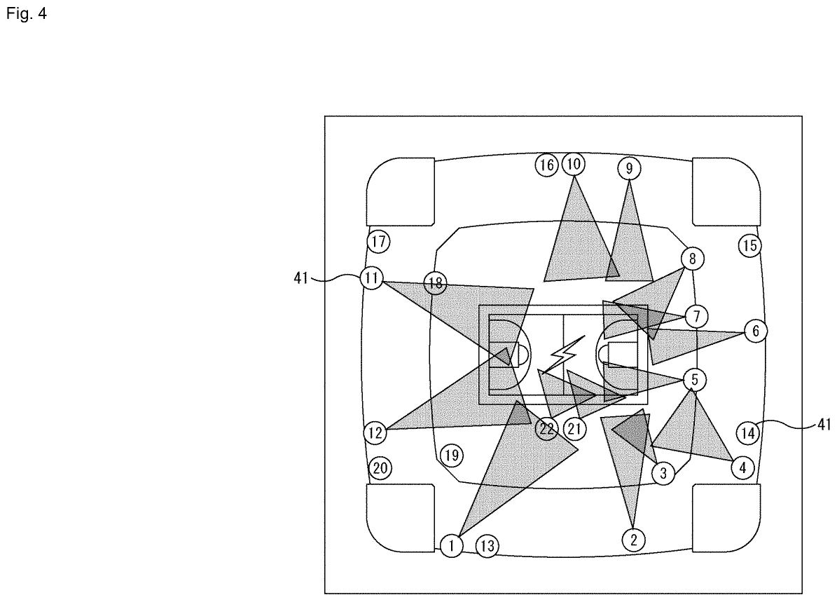

As an example of an application of the image processing system 1 described above, a case will be considered in which the image processing system 1 is applied to broadcasting a sports game. For example, as illustrated in FIG. 4, a plurality of cameras 41 indicated by circles are installed at a basketball game venue. The plurality of cameras 41 are installed to surround the court from various positions and directions, such as close to the court and at a distance to capture an image of the entire court. In the example of FIG. 4, the numbers illustrated in the circles representing the respective cameras 41 are camera numbers for identifying the plurality of cameras 41, and in the example of FIG. 4, a total of 22 cameras 41 are installed, but the arrangement and number of cameras 41 are merely an example and are not limited to this example.

In a volumetric image capture environment such as sports game broadcast, occlusion can inevitably occur due to limitations on the arrangement and number of cameras 41, the number of players for which 3D models are to be generated, and so on.

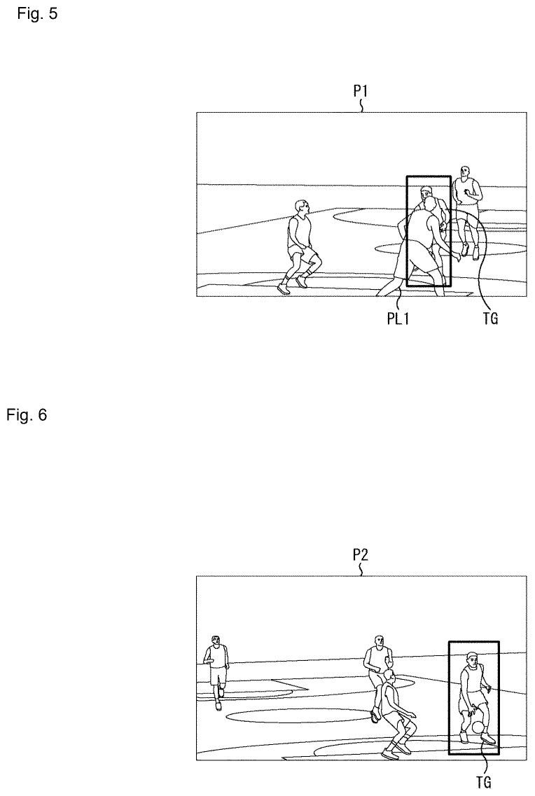

For example, images P1 to P5 in FIGS. 5 to 9 provide examples of images captured during a game at the same time by five cameras 41 installed at the game venue.

In the images P1 to P5 illustrated in FIGS. 5 to 9, the people for which 3D models are to be generated are, for example, players and a referee in the game. Of the players and the referee appearing in the images P1 to P5, the player enclosed by a rectangular frame is set as a target model TG, which is an object for which a 3D model is to be generated.

In the image P1 of FIG. 5 captured by a first camera 41, the target model TG partially overlaps with another player PL1, resulting in occlusion.

In the image P2 of FIG. 6 captured by a second camera 41, the target model TG does not overlap with any other player, resulting in no occlusion.

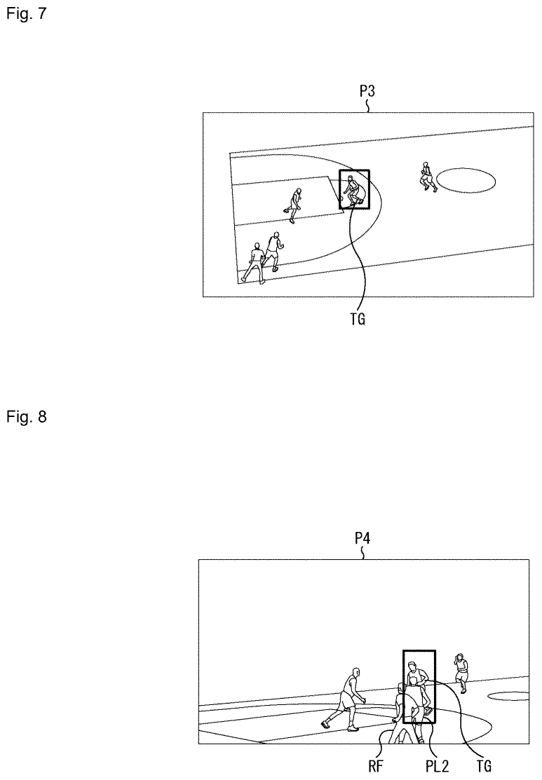

In the image P3 of FIG. 7 captured by a third camera 41, the target model TG does not overlap with any other player, resulting in no occlusion.

In the image P4 of FIG. 8 captured by a fourth camera 41, the target model TG partially overlaps with another player PL2 and the referee RF1, resulting in occlusion.

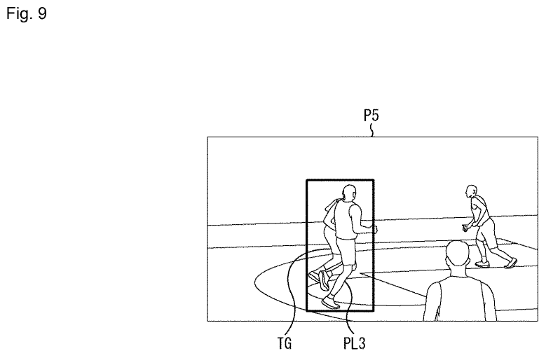

In the image P5 of FIG. 9 captured by a fifth camera 41, the target model TG partially overlaps with another player PL3, resulting in occlusion.

Of the five images P1 to P5 captured by the five cameras 41, no occlusion has occurred in two images P2 and P3, while occlusion has occurred in three images P1, P4, and P5. When occlusion occurs frequently in this way, a 3D model of the target model TG cannot be generated with high accuracy.

The 3D model generation unit 12 of the image processing system 1 in FIG. 1 is configured to be able to handle cases where such occlusion occurs frequently and a 3D model cannot be generated with high accuracy by using only the images captured by a plurality of cameras 41.

### 4. Detailed Configuration Block Diagram of 3D Model Generation Unit

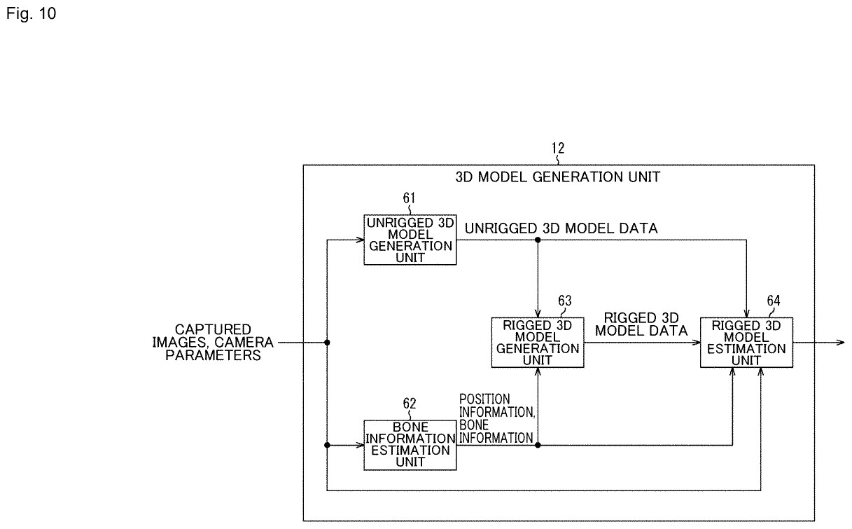

FIG. 10 is a block diagram illustrating a detailed configuration example of the 3D model generation unit 12.

The 3D model generation unit 12 includes an unrigged 3D model generation unit 61 serving as a first 3D model generation unit, a bone information estimation unit 62, a rigged 3D model generation unit 63 serving as a second 3D model generation unit, and a rigged 3D model estimation unit 64.

Images (captured images) captured by a plurality of cameras 41 installed at the game venue are supplied to the 3D model generation unit 12 via the data acquisition unit 11. In addition, camera parameters (internal parameters and external parameters) of each of the plurality of cameras 41 are also supplied from the data acquisition unit 11. The captured images and camera parameters of the cameras 41 are appropriately supplied to each unit of the 3D model generation unit 12.

The 3D model generation unit 12 generates, as a target model for which a 3D model is to be generated, a 3D model of each of the subjects appearing in captured images captured by the cameras 41, such as players and a referee. Data of the generated 3D model of the target model (3D model data) is output to the formatting unit 13 (FIG. 1).

The unrigged 3D model generation unit 61 (a first 3D model generation unit) is a 3D model generation unit that generates a 3D model of a target model by using captured images in which no occlusion has occurred. The 3D model of the target model thus generated is referred to as an unrigged 3D model, to distinguish it from a rigged 3D model described below.

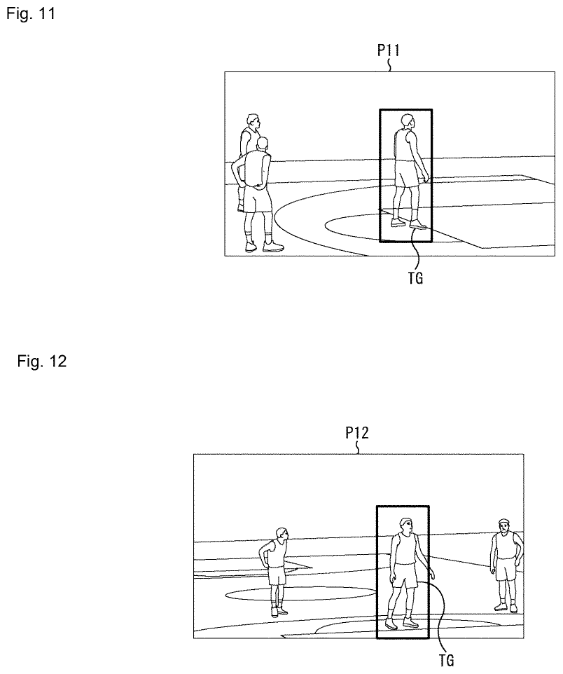

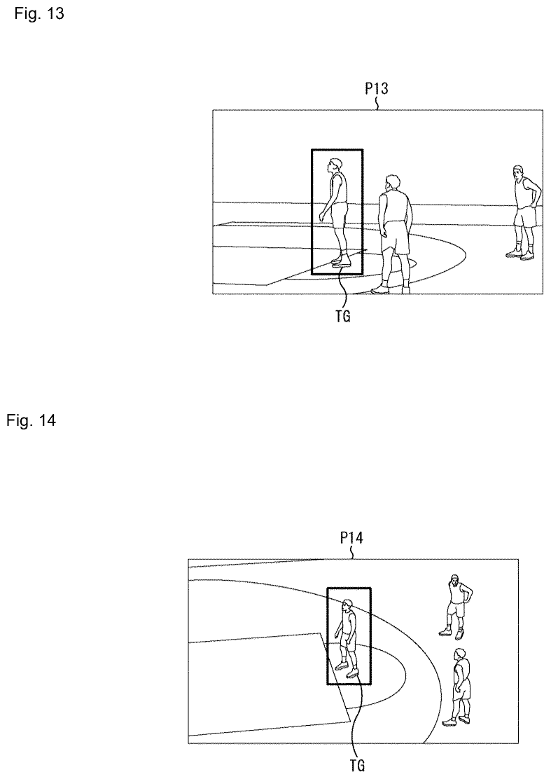

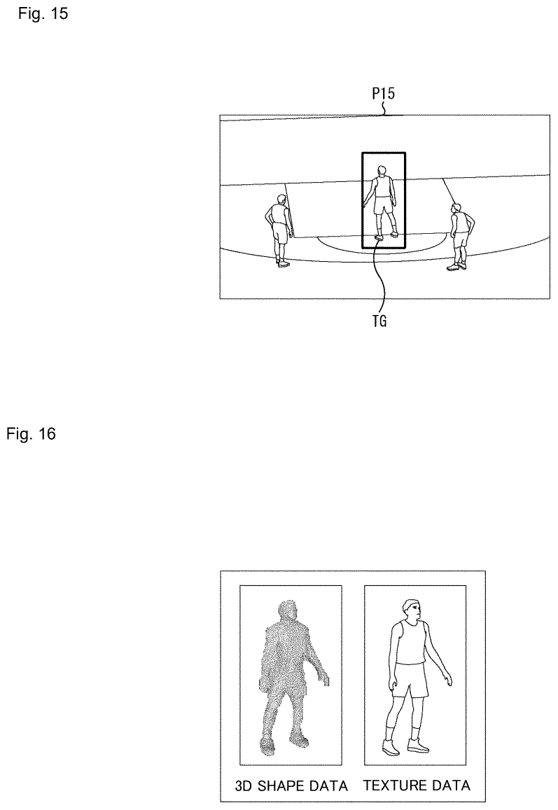

Images P11 to P15 in FIGS. 11 to 15 provide examples of captured images from which the unrigged 3D model generation unit 61 generates an unrigged 3D model.

The images P11 to P15 in FIGS. 11 to 15 are images captured during the game by the five cameras 41 at timings different from those of the images P1 to P5 in FIGS. 5 to 9.

Of the players and the referee appearing in the images P11 to P15 in FIGS. 11 to 15, the player enclosed by a rectangular frame is set as a target model TG. It can be seen that no occlusion has occurred on the target model TG in the five images P11 to P15. In such a case where no occlusion has occurred on the target model TG, for example, a 3D model can be generated in the same manner as the case where a 3D model is generated by capturing images of a target model TG in a dedicated studio. For example, the unrigged 3D model generation unit 61 generates a 3D model of the target model TG by using a visual hull to sharpen the three-dimensional shape of the target model TG using images (silhouette images) from the plurality of cameras 41, as described above.

FIG. 16 illustrates a conceptual diagram of data of an unrigged 3D model of the target model TG generated by the unrigged 3D model generation unit 61.

The 3D model data of the target model TG is composed of 3D shape data in a mesh format expressed by a polygon mesh, and texture data which is color information data. In the present embodiment, the texture data generated by the unrigged 3D model generation unit 61 is view independent texture data in which color information remains the same regardless of the viewing direction. Examples of the view independent texture data include UV mapping data in which two-dimensional texture images that are applied to each polygon mesh, which is 3D shape data, is expressed in a UV coordinate system and held.

Returning to the explanation of FIG. 10, the unrigged 3D model generation unit 61 supplies the generated 3D model data of the target model (hereinafter referred to as unrigged 3D model data) to the rigged 3D model generation unit 63 and the rigged 3D model estimation unit 64.

The bone information estimation unit 62 estimates bone information of the target model from images captured by the plurality of cameras 41 installed at the game venue. The bone information estimation unit 62 also estimates position information of the target model based on the estimated bone information. The bone information of the target model is expressed, for example, for each joint of the human body, by a joint id for identifying the joint, position information (x, y, z) that indicates the three-dimensional position of the joint, and rotation information R that indicates the rotation direction of the joint. For example, 17 joints of the human body are set, including the nose, right eye, left eye, right ear, left ear, right shoulder, left shoulder, right elbow, left elbow, right wrist, left wrist, right hip, left hip, right knee, left knee, right ankle, and left ankle. The position information of the target model is defined, for example, by the center coordinates, radius, and height of a circle that defines a cylindrical shape enclosing the target model, calculated based on the position information (x, y, z) of each joint position of the target model. Based on the captured images that are sequentially supplied as a moving image, the position information and bone information of the target model are sequentially calculated and tracked. The processing of estimating the bone information and position information of the target model can employ any known method. Even when occlusion has occurred in some of the images captured by the plurality of cameras 41, bone information of the target model can be estimated using captured images in which no occlusion has occurred.

The bone information estimation unit 62 supplies the position information and bone information of the target model estimated from the captured images as tracking data to the rigged 3D model generation unit 63 and the rigged 3D model estimation unit 64.

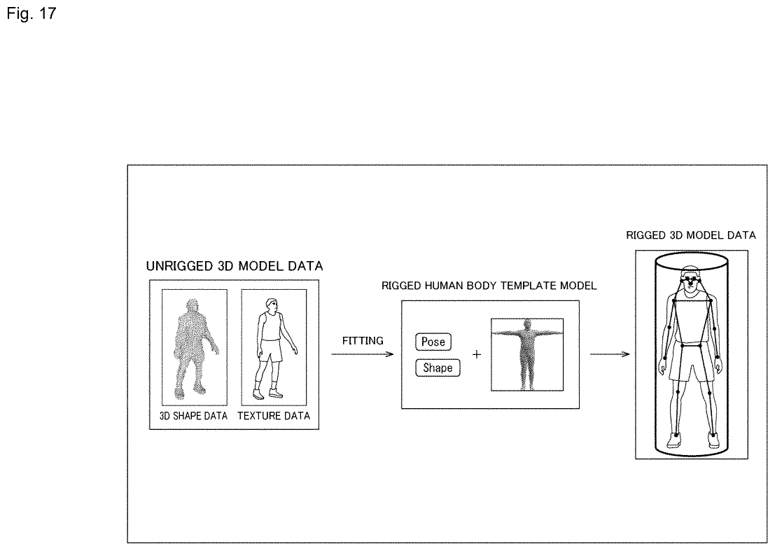

The rigged 3D model generation unit 63 (a second 3D model generation unit) generates a rigged 3D model of the target model by matching a rigged human body template model to the skeleton and body type (shape) of the target model. The rigged human body template model is a human body model including bone information (rigs) such as bones and joints, and whose body type can be generated parametrically. For the rigged human body template model, a human body parametric model such as SMPL disclosed in NPL 1 can be used. As illustrated in FIG. 17, for a rigged human body template model, in which the shape of the human body is expressed by pose parameters and shape parameters, an offset between each point of the SMPL and the corresponding point of the 3D shape data of the target model is calculated and fitted using the 3D model data of the target model supplied from the unrigged 3D model generation unit 61. Further, a rigged 3D model of the target model is generated by dividing the target model into meshes to express the shape of the target model in greater detail. The bone information of the rigged human body template model may reflect the bone information of the target model estimated by the bone information estimation unit 62.

The rigged 3D model generation unit 63 supplies data of the rigged 3D model of the target model (hereinafter referred to as rigged 3D model data) to the rigged 3D model estimation unit 64. The rigged 3D model data of the target model only needs to be generated once.

The rigged 3D model estimation unit 64 is supplied with the unrigged 3D model data of the target model corresponding to the moving image (captured images) captured by each camera 41 from the unrigged 3D model generation unit 61, and is also supplied with the rigged 3D model data of the target model from the rigged 3D model generation unit 63. In addition, the rigged 3D model estimation unit 64 is supplied with, as tracking data of the target model, the position information and bone information of the target model corresponding to the moving image (captured images) captured by each camera 41 from the bone information estimation unit 62.

The rigged 3D model estimation unit 64 determines whether or not occlusion has occurred on the target model in the captured images from the cameras 41. Whether or not occlusion has occurred can be determined from the position information of each target model supplied as tracking data from the bone information estimation unit 62 and the camera parameters of each camera 41. For example, when the target model is viewed from a predetermined camera 41, if the position information of the target model overlaps with the position information of another subject, it is determined that occlusion has occurred.

If it is determined that no occlusion has occurred, the rigged 3D model estimation unit 64 selects the unrigged 3D model data of the target model supplied from the unrigged 3D model generation unit 61, and outputs it as the 3D model data of the target model.

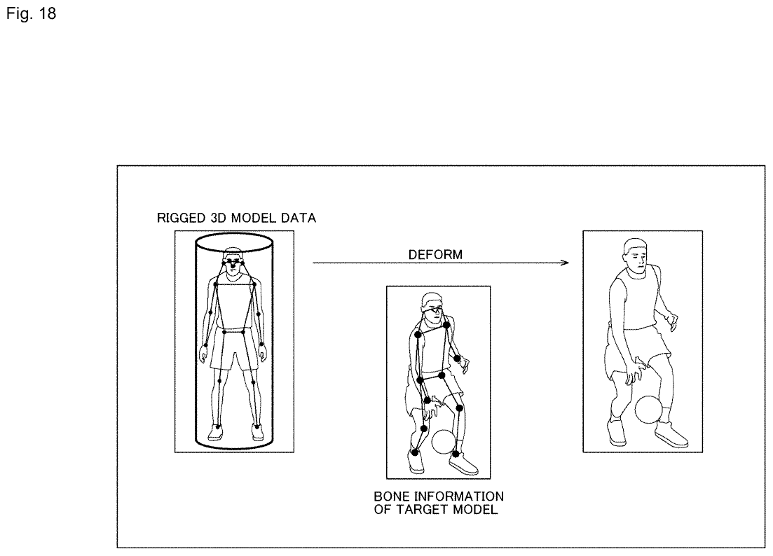

On the other hand, if it is determined that occlusion has occurred, the rigged 3D model estimation unit 64 generates (estimates) a 3D model of the target model (rigged 3D model) by reflecting the bone information of the target model supplied from the bone information estimation unit 62 in the rigged 3D model of the target model supplied from the rigged 3D model generation unit 63, as illustrated in FIG. 18. Specifically, the 3D model data of the target model is generated by deforming the rigged 3D model according to the bone information of the target model. The rigged 3D model estimation unit 64 outputs the generated 3D model data of the target model to a subsequent stage.

### 5. First 3D Moving Image Generation Processing

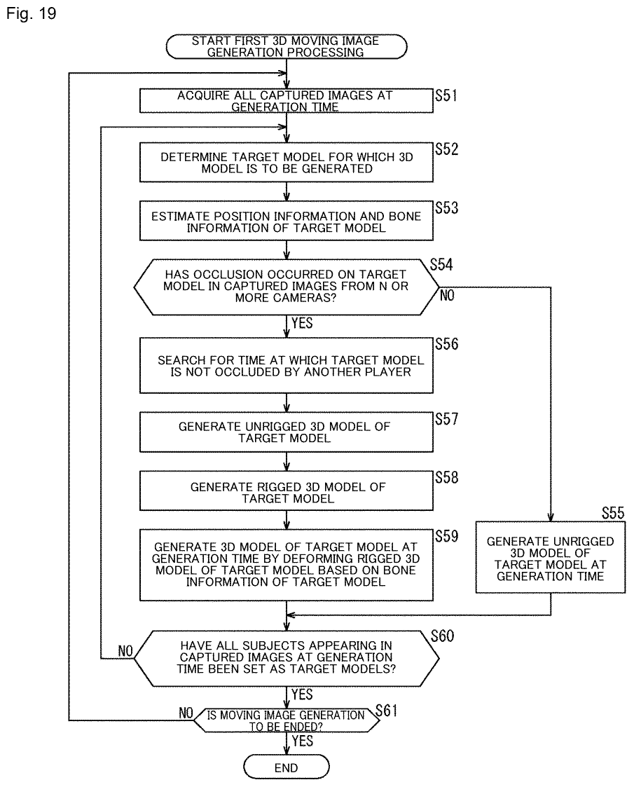

First 3D moving image generation processing by the 3D model generation unit 12 will be described with reference to a flowchart in FIG. 19. This processing is started, for example, in response to an instruction to generate a 3D moving image through an operation unit (not illustrated). The camera parameters of the cameras 41 installed at the game venue are assumed to be known.

First, in step S51, the 3D model generation unit 12 acquires all the captured images captured by the cameras 41 at a time (hereinafter referred to as a generation time) for a predetermined generation frame of a 3D moving image to be distributed. The 3D moving image to be distributed as a free viewpoint video is to be generated at the same frame rate as moving images captured by the cameras 41.

In step S52, the 3D model generation unit 12 determines, from one or more subjects in the captured images, a target model for which a 3D model is to be generated.

In step S53, the bone information estimation unit 62 estimates position information and bone information of the target model based on the captured images from the cameras 41. Specifically, position information (x, y, z) and rotation information R of each joint of the target model are estimated as bone information, and position information of the target model is estimated as the center coordinates, radius, and height of a cylindrical circle based on the estimated bone information. The estimated position information and bone information of the target model are supplied to the rigged 3D model generation unit 63 and the rigged 3D model estimation unit 64.

In step S54, the rigged 3D model estimation unit 64 determines whether occlusion has occurred on the target model in captured images from N or more cameras 41 (N>0).

If it is determined in step S54 that no occlusion has occurred on the target model in the captured images from N or more cameras 41, the processing proceeds to step S55, and then the unrigged 3D model generation unit 61 generates an unrigged 3D model of the target model at the generation time by using captured images from cameras 41 in which no occlusion has occurred. The generated unrigged 3D model data is supplied to the rigged 3D model estimation unit 64. The rigged 3D model estimation unit 64 outputs, as 3D model data of the target model, the unrigged 3D model data generated by the unrigged 3D model generation unit 61.

On the other hand, if it is determined in step S54 that occlusion has occurred on the target model in the captured images from N or more cameras 41, the processing proceeds to step S56, and then the unrigged 3D model generation unit 61 searches for a time at which the target model is not occluded by another player from among the captured images at other times that make up the moving image. Next, in step S57, the unrigged 3D model generation unit 61 generates an unrigged 3D model of the target model by using the captured images from the cameras 41 at the found time. The generated unrigged 3D model data is supplied to the rigged 3D model generation unit 63.

In step S58, the rigged 3D model generation unit 63 generates a rigged 3D model of the target model by using the 3D model data of the target model supplied from the unrigged 3D model generation unit 61 for the rigged human body template model. The generated rigged 3D model of the target model is supplied to the rigged 3D model estimation unit 64.

In step S59, by deforming the rigged 3D model of the target model based on the bone information of the target model at the generation time estimated in step S53, the rigged 3D model estimation unit 64 generates a 3D model of the target model at the generation time. The generated 3D model data of the target model is output to a subsequent stage.

In step S60, the 3D model generation unit 12 determines whether all the subjects appearing in the captured images at the generation time have been set as target models. If it is determined in step S60 that all the subjects have not yet been set as target models, the processing returns to step S52, and the above-described processing of steps S52 to S60 is performed again. Specifically, a subject that has not yet been set as a target model in the captured images at the generation time is determined to be the next target model, and 3D model data therefor is generated and output. A rigged 3D model needs to be generated once for one subject (target model), and the processing of steps S56 to 58 for the subject for which a rigged 3D model has been generated from the second time onwards may be omitted.

On the other hand, if it is determined in step S60 that all the subjects have been set as target models, the processing proceeds to step S61, and then the 3D model generation unit 12 determines whether or not to end the moving image generation. In step S61, if the 3D model generation unit 12 has performed the processing of generating 3D models for captured images at all times that make up a moving image supplied from each camera 41 (the processing of steps S51 to S60), the 3D model generation unit 12 determines to end the moving image generation, and if the 3D model generation unit 12 has not yet performed, the 3D model generation unit 12 determines not to end the moving image generation.

If it is determined in step S61 that the moving image generation has not yet been ended, the processing returns to step S51, and then the above-described processing of steps S51 to S61 is performed again. Specifically, the processing of generating a 3D model is performed for a captured image at a time when the generation of a 3D model has not yet been ended.

On the other hand, if it is determined in step S61 that the moving image generation is to be ended, the first 3D moving image generation processing ends.

The first 3D moving image generation processing is performed as described above. According to the first 3D moving image generation processing, it is determined whether or not occlusion has occurred on the target model in captured images from N or more cameras 41, and if no occlusion has occurred, a 3D model of the target model is generated using a method without using bone information. On the other hand, if occlusion has occurred on the target model, a 3D model of the target model is generated by deforming the rigged 3D model by using bone information.

### 6. Second 3D Moving Image Generation Processing

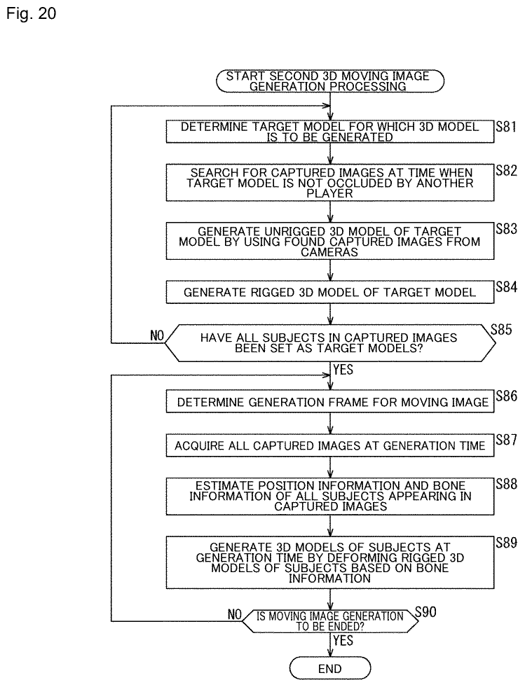

The 3D model generation unit 12 can perform second 3D moving image generation processing in FIG. 20 as another different method of generating a 3D moving image.

The second 3D moving image generation processing by the 3D model generation unit 12 will be described with reference to a flowchart in FIG. 20. This processing is started, for example, in response to an instruction to generate a 3D moving image through an operation unit (not illustrated). The camera parameters of the cameras 41 installed at the game venue are assumed to be known.

First, in step S81, the 3D model generation unit 12 determines a target model for which a 3D model is to be generated, from among one or more subjects in the captured images from the cameras 41.

In step S82, the unrigged 3D model generation unit 61 searches for captured images from cameras 41 at a time when the target model is not occluded by another player.

In step S83, the unrigged 3D model generation unit 61 generates an unrigged 3D model of the target model by using the found captured images from cameras 41. The generated unrigged 3D model data is supplied to the rigged 3D model generation unit 63.

In step S84, the rigged 3D model generation unit 63 generates a rigged 3D model of the target model by using the 3D model data of the target model supplied from the unrigged 3D model generation unit 61 for the rigged human body template model. The generated rigged 3D model of the target model is supplied to the rigged 3D model estimation unit 64.

In step S85, the 3D model generation unit 12 determines whether all the subjects in the captured images from the cameras 41 have been set as target models for generating 3D models.

If it is determined in step S85 that all the subjects have not yet been set as target models, the processing returns to step S81, and then the above-described processing of steps S81 to S85 is repeated again. Specifically, a subject that has not yet been set as a target model in the captured images is determined to be the next target model, and a rigged 3D model is generated.

On the other hand, if it is determined in step S85 that all the subjects have been set as target models, the processing proceeds to step S86, and then the 3D model generation unit 12 determines a predetermined generation frame for a 3D moving image to be distributed. As in the first 3D moving image generation processing, the 3D moving image to be distributed as a free viewpoint video is to be generated at the same frame rate as moving images captured by the cameras 41.

In step S87, the 3D model generation unit 12 acquires all the captured images captured by the cameras 41 at a time (hereinafter referred to as a generation time) for the determined generation frame.

In step S88, the bone information estimation unit 62 estimates position information and bone information of all the subjects appearing in the captured images at the generation time. The estimated position information and bone information of all the subjects are supplied to the rigged 3D model estimation unit 64.

In step S89, by deforming the rigged 3D models of the subjects based on the bone information estimated in step S88 for all the subjects appearing in the captured images at the generation time, the rigged 3D model estimation unit 64 generates 3D models of the subjects at the generation time. The generated 3D model data for the subjects is output to a subsequent stage.

In step S90, the 3D model generation unit 12 determines whether or not to end the moving image generation. In step S90, the 3D model generation unit 12 determines to end the moving image generation if all the frames that will make up the 3D moving image to be distributed have been generated, and determines not to end the moving image generation if all the frames have not yet been generated.

If it is determined in step S90 that the moving image generation has not been ended, the processing returns to step S86, and then the above-described processing of steps S86 to S90 is performed again. Specifically, the next generation frame for the 3D moving image to be distributed is determined, and processing of generating a 3D model is performed using the captured images at the time for the determined generation frame.

On the other hand, if it is determined in step S90 that the moving image generation is to be ended, the second 3D moving image generation processing ends.

The second 3D moving image generation processing is performed as described above. According to the second 3D moving image generation processing, first, a rigged 3D model of each subject is generated using captured images in which no occlusion has occurred. Then, bone information of each subject appearing in captured images that make up a moving image is tracked (bone information of each subject is sequentially detected), and a 3D model is generated by updating (sequentially deforming) the rigged 3D model based on the tracked bone information.

The first 3D moving image generation processing and the second 3D moving image generation processing can be appropriately selected and performed according to user settings and the like.

### 7. Conclusion

The 3D model generation unit 12 includes an unrigged 3D model generation unit 61 (a first 3D model generation unit) that generates an unrigged 3D model that is a 3D model not including bone information of a person, by using captured images captured by the a plurality of cameras 41, and a rigged 3D model generation unit 63 (a second 3D model generation unit) that generates, based on the bone information of the person, a rigged 3D model that is a 3D model including the bone information of the person. The 3D model generation unit 12 also includes a bone information estimation unit 62 that estimates, based on captured images captured at a predetermined time by the plurality of cameras 41, bone information of a person appearing in the captured images, and a 3D model estimation unit 64 that, when occlusion has occurred on the person appearing in the captured images at the predetermined time, estimates a 3D model of the person based on the bone information at the predetermined time.

Even when occlusion has occurred on the person appearing in the captured images captured by the plurality of cameras 41 at the predetermined time, a 3D model of the person at the predetermined time can be generated with high accuracy by deforming the rigged 3D model of the person based on the bone information at the predetermined time. This makes it possible to generate and distribute high-quality free viewpoint video. Since a 3D model can be generated with high accuracy even when occlusion has occurred, there is no need to increase the number of cameras 41 installed to prevent occlusion from occurring, and high-quality free viewpoint video can be generated with a small number of cameras.

### 8. Configuration Example of Computer

The series of processing in the image processing system 1 or the 3D model generation unit 12 described above can be performed by hardware or by software. In a case where the series of processing is performed by software, a program that configures the software is installed on a computer. Here, examples of the computer include a computer embedded in dedicated hardware or a general-purpose personal computer capable of executing various functions by installing various programs.

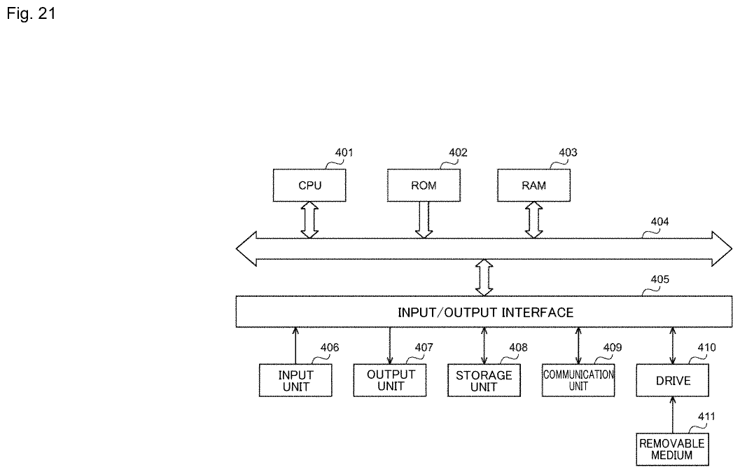

FIG. 21 is a block diagram illustrating a hardware configuration example of a computer when the computer executes the series of processing performed by the image processing system 1 or the 3D model generation unit 12 by means of a program.

In the computer, a central processing unit (CPU) 401, a read-only memory (ROM) 402, and a random access memory (RAM) 403 are connected to each other by a bus 404.

An input/output interface 405 is further connected to the bus 404. An input unit 406, an output unit 407, a storage unit 408, a communication unit 409, and a drive 410 are connected to the input/output interface 405.

The input unit 406 includes a keyboard, a mouse, a microphone, and the like. The output unit 407 includes a display, a speaker, and the like. The storage unit 408 is a hard disk, non-volatile memory, or the like. The communication unit 409 is a network interface or the like. The drive 410 drives a removable medium 411 such as a magnetic disk, an optical disc, a magneto-optical disk, or a semiconductor memory.

In the computer configured as described above, for example, the CPU 401 loads a program stored in the storage unit 408 into the RAM 403 via the input/output interface 405 and the bus 404 and executes the program to perform the above- described series of processing.

The program executed by the computer (the CPU 401) can be recorded on, for example, the removable medium 411 serving as a package medium for supply. The program can be supplied via a wired or wireless transmission medium such as a local area network, the Internet, or digital satellite broadcasting.

In the computer, by mounting the removable medium 411 on the drive 410, it is possible to install the program in the storage unit 408 via the input/output interface 405. The program can be received by the communication unit 409 via a wired or wireless transfer medium and can be installed in the storage unit 408. In addition, this program may be installed in advance in the ROM 402 or the storage unit 408.

The program executed by a computer may be a program that performs processing chronologically in the order described in the present specification or may be a program that executes processing in parallel or at a necessary timing such as a called time.

### 9. Application Example

The technology related to the present disclosure can be applied to various products or services.

### 9.1 Production of Content

For example, new video content may be created by synthesizing a 3D model of the subject generated in the present embodiment with the 3D data managed by another server. Further, for example, when background data acquired by an imaging device such as Lidar exists, it is possible to also create content in which the subject appears as if the subject is at a place indicated by the background data by combining the 3D model of the subject generated in the present embodiment with the background data. The video content may be three-dimensional video content or may be two-dimensional video content converted into two dimensions. The 3D model of the subject generated in the present embodiment is, for example, a 3D model generated by the 3D model generation unit or a 3D model reconstructed by the rendering unit.

### 9.2 Experience in Virtual Space

For example, a subject (for example, a performer) generated in the present embodiment can be disposed in a virtual space that is a place at which a user acts as an avatar and performs communication. In this case, the user can act as an avatar and view a live-action subject in the virtual space.

9.3 Application to Communication with Remote Place

For example, it is possible for a user at a remote place to view the 3D model of the subject through a reproduction device at the remote place by transmitting the 3D model of the subject generated by the 3D model generation unit from the transmission unit to a remote place. For example, it is possible for the subject and the user at the remote place to perform communication in real time by transmitting the 3D model of the subject in real time. For example, a case in which the subject is a teacher and the user is a student, or the subject is a doctor and the user is a patient can be assumed.

### 9.4 Others

For example, it is possible to generate a free viewpoint video of sports or the like on the basis of 3D models of a plurality of subjects generated in the present embodiment, or it is possible for an individual to distribute himself or herself as the 3D model generated in the present embodiment to a distribution platform. As described above, content of the embodiments described in the present specification can be applied to various technologies or services.

Further, for example, the above-described program may be executed in any device. In that case, the device may have required functional blocks so that the device can obtain required information.

Further, for example, each step of one flowchart may be performed by one device, or may be shared and executed by a plurality of devices. Further, when a plurality of kinds of processing are included in one step, one device may perform the plurality of kinds of processing, or the plurality of devices may share and perform the plurality of kinds of processing. In other words, it is also possible to perform the plurality of kinds of processing included in one step as processing of a plurality of steps. On the other hand, it is also possible to perform processing described as a plurality of steps collectively as one step.

Further, for example, in a program that is executed by a computer, processing of steps describing the program may be executed in time series in an order described in the present specification, or may be executed in parallel or individually at a required timing such as when call is made. That is, the processing of the respective steps may be executed in an order different from the above-described order as long as there is no contradiction. Further, the processing of the steps describing this program may be executed in parallel with processing of another program, or may be executed in combination with the processing of the other program.

Further, for example, a plurality of technologies regarding the present technology can be independently implemented as a single body as long as there is no contradiction. Of course, it is also possible to perform any plurality of the present technologies in combination. For example, it is also possible to implement some or all of the present technologies described in any of the embodiments in combination with some or all of the technologies described in other embodiments. Further, it is also possible to implement some or all of any of the above-described technologies in combination with other technologies not described above.

The technology of the present disclosure can be configured as follows.
(1)

An image processing device including:
a bone information estimation unit that estimates, based on captured images at a predetermined time captured by a plurality of imaging devices, bone information of a person appearing in the captured images; and
a 3D model estimation unit that, when occlusion has occurred on the person appearing in the captured images at the predetermined time, estimates a 3D model of the person based on the bone information at the predetermined time.
(2)

The image processing device according to (1), wherein
the bone information estimation unit estimates position information of the person based on the bone information of the person, and
the 3D model estimation unit determines whether occlusion has occurred on the person based on the position information of the person.
(3)

The image processing device according to (1) or (2), wherein when occlusion has occurred on the person appearing in captured images from a predetermined number of imaging devices or more, the 3D model estimation unit determines that occlusion has occurred on the person.
(4)

The image processing device according to any one of (1) to (3), further including:
a first 3D model generation unit that generates, by using the captured images captured by the plurality of imaging devices, an unrigged 3D model that is a 3D model not including the bone information of the person; and
a second 3D model generation unit that generates, based on the bone information of the person, a rigged 3D model that is a 3D model including the bone information of the person.
(5)

The image processing device according to (4), wherein the 3D model estimation unit estimates the 3D model of the person at the predetermined time by deforming the rigged 3D model of the person based on the bone information at the predetermined time.
(6)

The image processing device according to (4) or (5), wherein the first 3D model generation unit generates the unrigged 3D model of the person by using captured images in which no occlusion has occurred on the person.
(7)

The image processing device according to any one of (4) to (6), wherein
the bone information estimation unit tracks the bone information of the person appearing in the captured images that are sequentially supplied, and
the 3D model estimation unit updates the 3D model of the person based on the tracked bone information.
(8)

The image processing device according to any one of (1) to (7), further including a first 3D model generation unit that generates, based on captured images at a predetermined time captured by the plurality of imaging devices, an unrigged 3D model that is a 3D model not including the bone information of the person,
wherein when no occlusion has occurred on the person, the 3D model estimation unit outputs the 3D model of the person generated by the first 3D model generation unit.
(9)

An image processing method including: by an image processing device,
estimating, based on captured images at a predetermined time captured by a plurality of imaging devices, bone information of a person appearing in the captured images; and
estimating, when occlusion has occurred on the person appearing in the captured images at the predetermined time, a 3D model of the person based on the bone information at the predetermined time.
(10)

A program for causing a computer to execute processing of:
estimating, based on captured images at a predetermined time captured by a plurality of imaging devices, bone information of a person appearing in the captured images; and
estimating, when occlusion has occurred on the person appearing in the captured images at the predetermined time, a 3D model of the person based on the bone information at the predetermined time.

### REFERENCE SIGNS LIST

1 Image processing system
11 Data acquisition unit
12 3D model generation unit
41 Imaging device (camera)
61 Unrigged 3D model generation unit (first 3D model generation unit)
62 Bone information estimation unit
63 Rigged 3D model generation unit (second 3D model generation unit)
64 Rigged 3D model estimation unit
401 CPU
402 ROM
403 RAM
406 Input unit
407 Output unit
408 Storage unit
409 Communication unit
410 Drive
411 Removable medium

1. An image processing device comprising:
a bone information estimation unit that estimates, based on captured images at a predetermined time captured by a plurality of imaging devices, bone information of a person appearing in the captured images; and
a 3D model estimation unit that, when occlusion has occurred on the person appearing in the captured images at the predetermined time, estimates a 3D model of the person based on the bone information at the predetermined time.

2. The image processing device according to claim 1, wherein
the bone information estimation unit estimates position information of the person based on the bone information of the person, and
the 3D model estimation unit determines whether occlusion has occurred on the person based on the position information of the person.

3. The image processing device according to claim 1, wherein when occlusion has occurred on the person appearing in captured images from a predetermined number of imaging devices or more, the 3D model estimation unit determines that occlusion has occurred on the person.

4. The image processing device according to claim 1, further comprising:
a first 3D model generation unit that generates, by using the captured images captured by the plurality of imaging devices, an unrigged 3D model that is a 3D model not including the bone information of the person; and
a second 3D model generation unit that generates, based on the bone information of the person, a rigged 3D model that is a 3D model including the bone information of the person.

5. The image processing device according to claim 4, wherein the 3D model estimation unit estimates the 3D model of the person at the predetermined time by deforming the rigged 3D model of the person based on the bone information at the predetermined time.

6. The image processing device according to claim 4, wherein the first 3D model generation unit generates the unrigged 3D model of the person by using captured images in which no occlusion has occurred on the person.

7. The image processing device according to claim 4, wherein
the bone information estimation unit tracks the bone information of the person appearing in the captured images that are sequentially supplied, and
the 3D model estimation unit updates the 3D model of the person based on the tracked bone information.

8. The image processing device according to claim 1, further comprising a first 3D model generation unit that generates, based on captured images at a predetermined time captured by the plurality of imaging devices, an unrigged 3D model that is a 3D model not including the bone information of the person,
wherein when no occlusion has occurred on the person, the 3D model estimation unit outputs the 3D model of the person generated by the first 3D model generation unit.

9. An image processing method comprising: by an image processing device,
estimating, based on captured images at a predetermined time captured by a plurality of imaging devices, bone information of a person appearing in the captured images; and
estimating, when occlusion has occurred on the person appearing in the captured images at the predetermined time, a 3D model of the person based on the bone information at the predetermined time.

10. A program for causing a computer to execute processing of:
estimating, based on captured images at a predetermined time captured by a plurality of imaging devices, bone information of a person appearing in the captured images; and
estimating, when occlusion has occurred on the person appearing in the captured images at the predetermined time, a 3D model of the person based on the bone information at the predetermined time.
